(19) United States
(12) Patent Application Publication
(10) Pub. No.: US 2009/0145332 A1
(43) Pub. Date: Jun. 11, 2009

(54) PROCESS

(75) Inventor: Ian Robert Wheeler, By Kinross (GB)

Correspondence Address: NIXON & VANDERHYE, PC, 901 NORTH GLEBE ROAD, 11TH FLOOR, ARLINGTON, VA, 22203, US

(73) Assignee: DUNWILCO (1198) LIMTED BRITISH BODY CORPORATE, EDINBURGH (GB)

(21) Appl. No.: 11/990,526

(22) PCT Filed: Aug. 17, 2006
(86) PCT No.: PCT/GB2006/003078

§ 371 Date: Feb. 15, 2008

(30) Foreign Application Priority Data
Aug. 18, 2005 (GB) 0516968.5

(51) Int. Cl. C04B 14/00; B29C 35/08

(52) U.S. Cl. 106/400; 264/400

(57) ABSTRACT

The present invention provides a process of preparing particulate products, the process comprising the steps of: (i) subjecting a precursor film to a non-mechanical particulate-defining treatment; and (ii) separating the particulate portion and the non-particulate portion of the film.

The present invention provides a process of preparing flattened organic or inorganic particulates, in particular a process of preparing such particulates having a narrow particle size distribution. The flattened organic and inorganic particulates prepared by the process find use in aesthetic and functional applications, especially as colouring agents.

In the field of colorants, more specifically pigments, flattened organic and inorganic particulates are commonly referred to as flakes. Commercially available flake particles are of two main types, metallic and non-metallic. They encompass a wide range of particle sizes, from 5 μm to 1000 μm or more in diameter, with aspect ratios (the ratio of the largest dimension to the smallest; effectively the diameter to thickness ratio) of about 15:1 to around 150:1 or even up to 250:1 or more. Such particles find use for the coloration of inks, paints, plastics and powder coatings, to impart an appearance not attainable from non-flake, organic or inorganic pigments. Depending on their chemical composition, they may also have a number of functional applications, such as electrical conductivity, heat and light reflection, moisture barrier or flame retardancy.

For many applications, it is advantageous for the flake particles to be of uniform size, particularly when used as pigments. For example, in gravure printing applications, excessively large flakes may block the printing cells, thereby reducing the quality of print. In contrast, very small flakes can reduce the cleanliness of tone of coatings in which they are incorporated. Indeed, the brightest effects are generally derived from a narrow particle size distribution; that is to say, from a product incorporating neither very large, nor very small flakes relative to the median.

The preparation of metal flake particles, for example for use as pigments, is well documented in the patent literature. They may be prepared from metal powder in the complete absence of solvent by a dry ball milling process, but this can be hazardous in the case of reactive metals such as aluminium, due to the contaminating and/or explosive properties of the dry flake products. For such metals, dry milling has been largely superseded by wet ball milling processes in which metal powder is milled with an organic liquid such as mineral spirits and a small amount of a lubricant. The cascading action of grinding media within the ball mill causes the substantially spherical metal powder to be flattened out into flakes having the recited aspect ratios.

Irrespective of the method of milling, the most common starting material is atomised metal powder. This is prepared by melting the bulk metal then forcing it through a nozzle by means of compressed gas. Thus bulk metal is converted to powder requiring further mechanical action in the ball mill to form flakes.

Older production processes produce flakes with angular edges and uneven surfaces, known in the art as “cornflakes”. A more recent development relating to aluminium is so-called “silver dollar” flakes. These are distinguished by more rounded edges, smoother, flatter surfaces and a narrower particle size distribution. In consequence, they have a brighter, whiter and more desirable appearance.

A further process for producing metal flakes involves coating a release coated polymer film with metal using a vacuum deposition technique. The release coating is subsequently dissolved to release a metal film that is subsequently disintegrated into flakes.

The non-metal commercially available flake particles used as pigments include pearlescent or mica flakes. These are traditionally derived from naturally occurring deposits of plate-like, silicate minerals, although more modern forms may be synthesised.

Glitter flakes are another type of commercially available pigment flakes. These are manufactured from very thin sheets of metal or surface metallised polymer film that are cut into regular geometric shapes by mechanical action. The drawback of this technique is that it is only able to make relatively large flakes, the minimum flake size being about 50 μm.

Apart from glitter flakes, a characteristic shared by conventional metal and non-metal, in particular pearlescent flake particles, is their wide particle size distribution. The particle size distribution of typical conventional metal flake particles and pearlescent flake particles are shown in Table 1 and Table 2 respectively. In use as pigments, the coarser flakes provide a sparkling effect, but little hiding power (opacity). In contrast, the finer flakes contribute opacity, but are of darker appearance. In practice, flake pigment manufacturers strive to produce products with a narrower particle size distribution, as in so doing, the aesthetic effect is maximised.

Creation of a substantially monodisperse product is not possible using the above-described conventional methods of preparing the two classes of flake pigment.

The present invention overcomes the problems of the prior art.

### DISCLOSURE OF THE INVENTION

In a first aspect the present invention provides a process of preparing particulate products, the process comprising the steps of (i) subjecting a precursor film to a non-mechanical particulate-defining treatment; and (ii) separating the particulate portion and the non-particulate portion of the film.

In a second aspect, the present invention provides a process of producing flake products, the process comprising the steps of (i) subjecting a flake precursor film to a non-mechanical flake-defining treatment; and (ii) separating the flake portion and the non-flake portion of the film.

The process of the present invention is particularly advantageous because it allows the size and shape of the flake products to be controlled such that substantially monodisperse flake products may be produced.

In a third aspect, the present invention provides a pigment composition comprising flake products having a median particle diameter of 100 μm or less and a particle size distribution such that at least 90% by volume of the flake products have a particle diameter within ±25% of the median particle diameter.

In further aspects, the present invention provides the use of flake products prepared by the process of the present invention
as a pigment;
for electro magnetic interference (EMI) shielding;
for providing gas barrier and/or liquid barrier properties to a surface coating or food packaging;
for providing heat and light reflection; or
for providing flame retardancy.

### FIGURE

FIG. 1 shows an array of circles that represent the flake portion of the flake precursor film.

### DETAILED DESCRIPTION

### Process

As previously mentioned, in a first aspect, the present invention provides a process of preparing particulate products, the process comprising the steps of (i) subjecting a precursor film to a non-mechanical particulate-defining treatment; and (ii) separating the particulate portion and the non-particulate portion of the film.

In a preferred aspect, the present invention provides a process of producing flake products, the process comprising the steps of (i) subjecting a flake precursor film to a non-mechanical flake-defining treatment; and (ii) separating the flake portion and the non-flake portion of the film.

The term “non-mechanical flake-defining treatment” means a non-mechanical treatment that demarcates an array of discrete shapes (the flakes) on the flake precursor film thereby creating a flake portion of the film and a non-flake portion of the film. It will be readily understood by the skilled person that as the flake-defining treatment is a-non-mechanical treatment, it does not include cutting the film with a blade or guillotine or stamping the film with a cutter.

The term “flake” refers to a particle having an aspect ratio of at least 3:1 wherein the aspect ratio is defined as the ratio of the largest dimension to the smallest dimension. In one preferred aspect, the flakes have an aspect ratio of at least 5:1. According to a preferred aspect of the invention the flakes have a substantially circular face and the aspect ratio is then the ratio of the diameter of the circular face to the thickness.

Typically, the flakes are non-metal flakes. These non-metal flakes may be recovered without further processing as flake products. Alternatively, these non-metal flakes may be further treated, for instance by coating with metal or metal compounds, and then recovered as metallised flake products. The flakes may also be milled either before or after coating.

The term “flake products” as used herein is a generic term referring to the finished materials and encompassing flakes and flakes coated with metal and/or metal compounds. Optionally these flakes may have been milled. The flake products preferably have a median particle diameter of 1000 μm or less, more preferably 500 μm or less, more preferably 200 μm or less, more preferably 100 μm or less, and in a highly preferred aspect 50 μm for less.

### Flake Precursor Film

In a preferred aspect, the flake precursor film is or is formed from a non-metal flake precursor. According to this aspect, the flakes are non-metal flakes.

Examples of suitable non-metal flake precursors include precursors of glass flakes such as sol gels, low melt temperature glass or other ceramic compositions, organic silicates such as tetraethyl orthosilicate, inorganic silicates, such as alkali metal silicates and other film-forming inorganic compounds, solid and liquid resins and polymers, solutions such as resin or polymer solutions and precursors of synthetic bismuth oxychloride flakes such as bismuth nitrate.

Preferably the non-metal flake precursor is a sol gel, a resin, a polymer, a resin or polymer solution, or bismuth nitrate. More preferably the non-metal flake precursor is a sol gel, a resin, a polymer or a resin or polymer solution. It is further preferred that the flake precursor is of good thermal and chemical stability.

The resin may advantageously be an electron beam or UV curable resin, a thermosetting resin such as an epoxy resin or an air drying resin, such as a polysiloxane resin, of which the Silikophen products of Tego Chemie GmbH are examples.

In one embodiment, the flake precursor contains a fine dispersion of organic or inorganic colorants. This embodiment is particularly preferred when the flake product is to be used as a pigment, for example by dispersion in a pigment carrier. In this embodiment the flake products need not be coated since their colour can be controlled by selection of appropriate colorants. The organic or inorganic colorants may also be used as a means of controlling the brittleness of the flake products.

### Substrate

In one preferred aspect the process of the invention further comprises the step of applying the flake precursor film to a substrate prior to the flake-defining treatment.

In this aspect the process preferably also comprises the step of removing the flake portion of the film from the substrate after the flake-defining treatment. Preferably the flake portion of the film is removed from the substrate by mechanical means or by washing with a recovery liquid.

Thus in one aspect, the present invention provides a process of preparing flake products, the process comprising the steps of: (i) applying a flake precursor film to a substrate; (ii) subjecting the film to a flake-defining treatment; (iii) separating the flake portion and the non-flake portion of the film; and (iv) removing the flake portion of the film from the substrate.

It will be readily understood that separating the flake portion and the non-flake portion of the film in step (iii) above may involve removal of one or both of these portions from the substrate. Typically only one portion of the film is removed from the substrate in step (iii). In this case, the remaining portion is removed from the substrate in step (iv).

Step (i) above of applying a film to a substrate may involve forming a film on a substrate or simply bringing a pre-formed film into contact with a substrate. In some cases pre-formed films of flake precursor may be available commercially or may be provided independently for use in this aspect of the present invention.

In one preferred aspect, the flake precursor film is a multi-layer film, and is preferably made up of a number of layers of film of different refractive index. Properties such as optical properties of the flakes may be adjusted by varying the number of layers of film, the refractive index of each layer of film and/or the thickness of each layer. Thus different colour effects can be achieved, in particular a pearlescent effect can be achieved. This aspect is particularly preferred when the flake product is to be used as a pigment and according to this aspect the flakes need not be coated.

As previously mentioned, in a preferred aspect the flake precursor film is formed on a substrate. The film may be formed at ambient or elevated temperature by any conventional method, taking into account the nature of the flake precursor. Examples of suitable film forming processes include printing processes, such as conventional printing and ink jet printing, bar coating, doctor blade or knife coating, extrusion and compression moulding or use of a spinning plate or 2 or 3 roll mills.

A number of these processes are particularly suitable for liquids, such as solutions, dispersions and slurries that are relatively free-flowing, for instance radiation curable liquid resins, such as UV or electron beam curable resins.

Alternatively, certain flake precursors may be laid down in films by using an ink jet printing method in which the inkjet droplets impinge one on another and coalesce to form a film. The size of the droplets may be determined in part by the orifice size of the ink jet printer head and this can be selected as appropriate for efficient film forming.

The jet head may be an ink jet printer head that has been modified to hold a liquid flake precursor in the reservoir in place of conventional ink. The mechanism by which the jet head delivers the droplets of the flake precursor is not critical, providing the materials of construction are unaffected by the chemical nature of the precursor in use and the temperature of operation. Ink jet printers of the continuous ink jet (CIJ) and drop-on-demand (DOD) types are especially amenable to the process of the invention.

The thickness of the film will usually be controlled by conventional means according to the selected film-forming method and flake precursor. Films intended for the production of small particle size flakes will generally be thinner than those intended for large flakes.

The film thickness will typically be between 0.1 μm and 15.0 μm, such as between 0.1 μm and 8.0 μm, or between 0.1 μm and 5.0 μm, or between 0.1 μm and 3.0 μm, or between 0.1 μm and 2 μm, or between 0.1 μm and 1.0 μm. In one aspect, the film thickness is between 0.5 μm and 5.0 μm, more preferably between 1.0 μm and 2.0 μm, such as about 1.5 μm. In another aspect, the film thickness is preferably between 0.2 μm and 1.0 μm, more preferably between 0.4 μm and 0.6 μm, such as about 0.5 μm.

When the film is produced by ink jet printing the size and spatial distribution of droplets of the flake precursor on the substrate may be controlled by the jet head drive electronics and the relative motion of the jet head and the substrate. When the film is formed on the substrate by ink jet printing, the substrate preferably moves horizontally below the jet head. Droplet thickness and surface characteristics of the film may be controlled by adjusting the viscosity of the precursor droplet, the length of the droplet's flight path onto the substrate and the contact angle and surface tension relationship between the precursor and substrate materials. The optimum operating conditions for a given combination of precursor and substrate may be determined by routine experimentation.

In a preferred embodiment, there is a differential motion between the jet head and the substrate. In practice, the jet head is generally fixed, with the substrate moving uniformly below it. In one embodiment the liquid flake precursor is ejected vertically downwards.

The substrate is preferably a solid. Preferably the substrate has a low friction coefficient. Examples of suitable substrates include polytetrafluoroethylene (PTFE), polyethylene, polypropylene, silicon, metal, glass or ceramic surfaces and substrates having release layers, such as organic release layers. The metal, glass or ceramic surfaces may be optionally polished to enhance their release properties.

The term “release layer” as used herein means a pre-applied release layer, typically a resin or polymer deposited from solution or suspension in a volatile liquid, designed to be subsequently redispersed or redissolved in the same or another liquid, in order to release the film.

The film may be expected to adopt the surface contours of the substrate. Therefore, the substrate preferably has a smooth surface and a low friction coefficient such that the flake precursor film may be readily removed from it. In this aspect PTFE and silicon are particularly preferred as substrates. Silicon is particularly advantageous because it exhibits good wetting, low adhesion which aids removal of the film and an extremely flat surface which produces a very smooth and hence highly reflective surface on the flake.

In another embodiment the substrate may have a release layer. One suitable substrate is paper, pre-coated by a release layer of dry Hi-Selon C-200 polyvinyl alcohol, (available from British Traders & Shippers Ltd.) deposited from aqueous solution. Another example of a substrate is a solution of PVP (polyvinyl pyrrolidone) K15, which is coated onto Melinex film and allowed to dry.

In one preferred embodiment, the substrate is thermally durable. An example of a thermally durable substrate is a metal surface such as copper film or aluminium foil. Preferably a thermally durable substrate is utilised when the flake-defining treatment includes heating.

In one preferred embodiment, the substrate is or is on a continuous belt. A substrate that is or is on a continuous belt allows the entire process to be carried out under continuous operation, with the resulting economies of production. Thus the film may be applied to the substrate at stage 1; subjected to a flake-defining treatment at stage 2; the flake and non-flake portions separated at stage 3; and the flakes recovered as flake products at stage 4; where at least stages 1 to 3 are carried out at a different location through which the continuous belt passes.

Removal from Substrate

In one embodiment the optionally coated flakes are removed from the substrate by mechanical means. Suitable mechanical means include using ultrasonics or a scraping device such as a doctor blade.

In another embodiment the optionally coated flakes are removed from the substrate by means of a jet of liquid or air at elevated pressure.

In another embodiment the optionally coated flakes are removed from the substrate by washing with a recovery liquid. Providing it does not react undesirably with the flakes, water or any common organic compound finding use as a solvent may be employed as a recovery liquid. In one preferred embodiment the recovery liquid is water.

A thin layer of recovery liquid may be passed across the surface of the substrate, which may itself be mobile or static. In this way, the flake precursor film is formed directly on the liquid's surface, for easy removal of the optionally coated flakes. Alternatively, when the substrate is a release layer, the release layer may be dispersed or dissolved in a recovery liquid. It may be advantageous to use as a release layer a material that contributes to the final application; for example a resin that in a derived surface coating becomes a permanent, film-forming part of that coating.

In one aspect the optionally coated flakes in the recovery liquid may be in a form convenient for sale or for further processing. This may achieved by using a recovery liquid that is compatible with the envisaged application. For certain applications, it may be necessary to concentrate the flakes in the recovery liquid, for example to form a conventional flake paste for ease of handling. Where this is the case, a filter press or other well-known means of separating solid particulates from liquids may be used.

Use of a recovery liquid has the advantage of removing the problem of dust contamination of the workplace.

To render the flake products of the process of the invention compatible with plastics and certain printing inks, it is preferable to avoid high boiling recovery liquids, either by dry recovery of the optionally coated flakes or through their conversion into a liquid free form, such as granules, using for example the process described in European Patent 0134676B. If desired, the flakes may be immobilised by solid organic carrier material.

### Milling

According to one embodiment, the flake precursor film is milled. This may take place before or after the flake-defining treatment, before or after the separation step, and before or after coating. In this embodiment it may be advantageous if the film is applied to substrate that is or is on the moving rolls of a roll mill.

The term “milling” as used herein includes any mechanical work performed so as to deform the film or flakes by moving milling media, for instance, by conventional ball milling, and alternatively, by roll milling, such as with a nip roll.

In one aspect, the optionally coated flakes are milled. The flakes must of course be sufficiently malleable to undergo physical deformation. According to this embodiment, the flakes may be allowed to impinge on the moving rolls of a two or three roll mill. The nip between the rolls is set to impart pressure on the flakes, flattening them further and causing them to assume the contours of the rolls, which may for example be used to impart a pattern on either or both of the flake surfaces. The surface quality of the flakes and hence the reflectivity of a pigment composition in which they are incorporated is dependent on the degree of surface polish of the rolls.

Incidentally, milling will of course change the particle size of the flakes and it may also affect the particle size distribution.

### Flake-Defining Treatment

In the first aspect of the present invention step (i) of the process involves a non-mechanical flake-defining treatment.

The term “non-mechanical flake-defining treatment” means a non-mechanical treatment that demarcates an array of discrete shapes (the flakes) on the flake precursor film thereby creating a flake portion of the film and a non-flake portion of the film.

The array is advantageously designed to maximise the area of the flake-portion of the film, thereby minimising wastage. The flakes may be different shapes depending on the intended application. For example the flakes may have a substantially circular, triangular, square, or rectangular face or may be in the form of rods, bars or fibres. In fact the flakes may have a face that is any shape that can be produced by this process although they will typically have a uniform thickness.

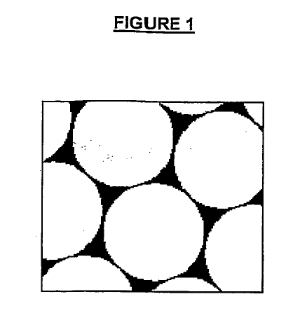

In one embodiment the flake-defining treatment demarcates an array of circles. An example of such an array is shown in FIG. 1 wherein the white circles represent the flakes.

Preferably the flake-defining treatment is a chemical, thermal or irradiative treatment or a combination thereof.

Examples of suitable chemical treatments include treatment with steam, treatment with ammonia vapour, treatment with hydrogen chloride gas or a mixture thereof. Examples of suitable thermal treatments include heating and cooling. Examples of suitable irradiative treatments include the application of electromagnetic radiation or particle radiation such as ultraviolet (UV) and electron bean (EB) curing, laser curing and laser ablation.

The flake-defining treatment typically alters physical and/or chemical properties of at least a portion of the flake precursor film. Typically only a portion of the flake precursor film is subjected to the flake-defining treatment.

In one embodiment a portion of the flake precursor film is masked from the flake-defining treatment. This allows control of the portion of the film that is subjected to the treatment. Masking may be achieved using techniques that are well known to the person skilled in the art. For example, when the flake-defining treatment is laser curing a laser mask projection machine may be utilised.

In one embodiment the flake-defining treatment is preferably a thermal or irradiative treatment or a combination thereof. These treatments are advantageous because they allow greater control over the portion of the flake precursor film that is subjected to the treatment. This allows increased accuracy in the demarcation of the flakes.

This aspect of the present invention provides advantages over the prior art. As previously mentioned, it is known to divide a film into flakes by mechanical means such as cutting or stamping but this is currently only feasible for particles sizes above about 50 μm. The process of the present invention may be used to create flake products having particle sizes significantly below 50 μm and having a narrow particle size distribution.

The flake-defining treatment will depend on the nature of the flake precursor. For example, when the flake precursor is a UV curable resin, UV curing may advantageously be used as the flake-defining treatment. When the flake precursor is tetraethyl orthosilicate, the flake-defining treatment may be treatment with an atmosphere of steam and ammonia vapour to fuse the tetraethyl orthosilicate to silica and optionally subsequent heat treatment to form glass. If bismuth nitrate is used as the flake precursor, the portion of the flake precursor film to be treated may be heated to around 400° C. and treated with a mixture of hydrogen chloride gas and air.

According to one preferred embodiment the flake-defining treatment is a solidification treatment. When a solidification treatment is applied it is typically the treated portion of the flake precursor film that becomes the flakes. The portion of the flake precursor film that is subjected to a solidification treatment becomes less soluble in an appropriate solvent than the untreated portion, allowing the untreated portion to be rinsed away. For example, when the flake precursor film is formed from a UV curable resin, treatment of a portion of the film with UV light will result in solidification of this portion of the film by curing. The uncured portion of the film may then be rinsed away.

According to another preferred embodiment the flake-defining treatment is an ablation treatment such as laser ablation. The portion of the film that undergoes laser ablation is effectively vaporised as a result of the laser breaking the chemical bonds in this portion of the film.

The laser may be used to delineate an array of discrete shapes by treating a portion of the film that outlines these shapes thereby effectively “cutting” the shapes in the film using the laser. The non-flake portion of the film may still be a continuous film that may be separated from the flakes as a single piece. For example the dark area surrounding the white circles in FIG. 1 could represent the non-flake portion of the film.

Alternatively the laser may be used to delineate an array of discrete shapes by treating the entire non-flake portion of the film. If the non-flake portion of the film is thereby vaporised, then the flake-defining treatment also separates the flake and non-flake portions of the film.

Following the flake-defining treatment the flakes may undergo further processing steps prior to recovery as flake products. For example the flakes may be solidified prior to recovery. This will depend on the nature of the flake precursor film. Mobile liquid films should of course be solidified to a sufficient extent prior to those flake-defining treatments that do not solidify the film, such as ablation treatments.

The flake-defining treatment demarcates the flakes and is therefore primarily responsible for the particle size and particle size distribution of the eventual flake products. The size and shape of the flakes may typically be determined by the portion of the flake precursor film that is subjected to the flake-defining treatment. Control of which portion of the film is subjected to the treatment is therefore an important aspect of the invention.

### Separation

As previously mentioned, the process of the invention involves the step of separating the flake portion and the non-flake portion of the film.

Preferably the flake and non-flake portions of the flake precursor film are separated by rinsing with a solvent. This is particularly suitable when the flake-defining treatment is a solidification treatment, for example the UV curing of the flake portion of a resin leaving the non-flake portion uncured. The nature of the solvent will depend on the specific flake precursor film. Examples of suitable solvents include water, alcohols, esters, ketones, glycols and hydrocarbons. Preferably, the solvent dissolves the non-flake portion of the flake precursor film. In this respect, esters and ketones are often good solvents for resins and for some polymers.

In one embodiment the portion of the film that does not become flake products is not discarded but is recycled, for example by being reused in the film forming step. If the rinsing solvent is the same as that from which the flake precursor film was deposited, recycling of the flake precursor film material may be facilitated.

As previously mentioned, in some embodiments the non-flake portion of the film may still be a continuous film that may be separated from the flakes as a single piece. When the film is on a substrate, this could be achieved, for example, by peeling the non-flake portion away from the substrate leaving the flakes on the substrate.

Alternatively the flake-defining treatment may also separate the flake and non-flake portions of the film, for example by ablation of the non-flake portion of the film.

### Coating

In one aspect, the process of the present invention further comprises the step of coating the film with metal and/or a metal compound. Preferred metal compounds for use in the present invention are metal oxides.

It is possible to undertake coating at any stage of the process provided this is compatible with the other steps adopted. It would, for instance, be possible to coat the film before or after the flake-defining treatment, or before or after separation of the flake and non-flake portions of the film. However, certain flake precursor films may not be chemically or physically suited to coating prior to the flake-defining treatment, for example when the film is a curable resin and the flake-defining treatment is curing. The film is preferably able to resist temperatures of up to 400° C. at the coating stage as this ensures thermal stability in all likely applications of the products of the invention. A further consideration is that certain flake-defining treatments may be incompatible with the presence of a coating. Furthermore material might be wasted by coating the film prior to separation of the flake portion and the non-flake portion of the film, if the non-flake portion is to be discarded.

Therefore, in one preferred aspect, the present invention further comprises the step of coating the flake portion of the film.

Thus, in one aspect, the present invention provides a process of preparing flake products, the process comprising the steps of: (i) subjecting-a flake precursor film to a flake-defining treatment; (ii) separating the flake portion and the non-flake portion of the film; and (iii) coating the flake portion of the film with metal and/or a metal compound.

It will be readily understood that the term “coated flakes” as used herein refers to flakes that have been coated with metal and/or a metal compound.

When the flake precursor film is applied to a substrate, the film may be coated before or after removal of the film from the substrate. When only the flake portion of the film is to be coated, the flakes may be coated either before or after removal from the substrate. If it is desirable for both sides of the final flake products to be coated then coating the flakes after removal from the substrate is generally preferred. However, if only one side of each final flake product is to be coated, and this is often sufficient for the desired metallic appearance of the pigment flakes, then coating prior to removal from the substrate is feasible. Coating only one side of the flake product is particularly applicable when the flakes are optically transparent and is advantageous because a smaller quantity of the metal and/or metal compound is required which leads to economic benefits.

If the flakes are milled, the coating may be applied before or after milling.

The film or flakes may be coated by well-known wet chemistry techniques or alternatively by well-known vacuum deposition techniques. For example, the flake and non-flake portions of the film may be separated and the flake portion may be removed from the substrate, if present, and subsequently coated by vacuum deposition techniques in a fluidised bed.

Digital metal deposition technology may also be used to coat the film or flakes. One known process involves jetting a silver nano-particulate ink onto a material (in this case, the film or flakes) followed by high temperature sintering to fuse the particles.

Another coating technique involves the use of a special flake precursor film that can be processed to form a semi-porous “sponge” into which the metal and/or metal compound is deposited. This film is formed from a flake precursor that has three components: a water soluble UV curable component, a water insoluble UV curable component and a transition metal catalyst. On curing, the two UV curable components separate into discrete phases to give a material that adheres strongly to most substrates. The water soluble phase may be dissolved out to leave a semi-porous sponge into which the metal and/or metal compound may be deposited by electroless deposition, for example, in an electroless copper bath. This technique is described in WO-A-04068389.

The film may be coated with more than one layer of metal and/or metal compound. The coating material used in each layer is independently selected from metals and metal compounds such that the layers may be of the same metal or metal compound or a combination of different metals and/or metal compounds. The thickness of each coating layer may also vary. Properties, such as optical properties, of the flake products may be adjusted by varying the number of layers of coating, the coating material used in each layer and/or the thickness of each layer. Thus different colour effects may be achieved.

Preferably the metal is aluminium, zinc, copper, tin, nickel, silver, gold or iron. In one preferred aspect, the metal is aluminium.

Preferably the metal compound is a metal oxide or the metal compound is an alloy comprising aluminium, zinc, copper, tin, nickel, silver, gold and/or iron. In one preferred aspect the metal compound is an alloy of copper and zinc. In another preferred aspect, the metal compound is a metal oxide selected from oxides of aluminium, zinc, copper, tin, nickel, silver, iron, titanium, manganese, molybdenum and silicon.

The coated flakes may be passivated during their preparation by treatment with corrosion inhibiting agents, for example by the addition of one or more corrosion inhibiting agents to a recovery liquid containing the coated flakes. This may be particularly desirable when the flakes are coated with a metal such as aluminium, zinc, copper, silver, or iron.

Any compounds capable of inhibiting the reaction of the metal and/or metal compound with water may be employed as corrosion inhibitors. Examples are phosphorus-, chromium-, vanadium-, titanium- or silicon-containing compounds. They may be used individually or in admixture.

Certain coated flakes may be treated with ammonium dichromate, silica or alumina to improve stability in aqueous application media. Other treatments may be used to provide coloration of the surface of the flake product, for example to simulate gold. Still further treatments may improve the hardness and therefore the shear resistance of such flake products in application media.

### Process Steps

It will be readily understood that the process steps described above may be carried out in a number of different sequences. A number of processes according to the present invention are detailed below in Table 3, although the invention is not limited to these particular processes. The numbers, 1, 2, 3 etc. denote the order of the process steps.

TABLE 3

| | | Flake- | | | | Remove | Recover |
|---|---|---|---|---|---|---|---|
| | Form | defining | Sepa- | | | from | flake |
| Process | film | treatment | ration | Coat | Mill | substrate | products |
| a | 1 | 2 | 3 | 4 | | 5 | |
| b | 1 | 2 | 3 | 4 | 5 | 6 | |
| c | 1 | 2 | 3 | | 4 | 5 | |
| d | 1 | 2 | 3 | 5 | 4 | 6 | |
| e | 1 | 2 | 3 | 5 | | 4 | 6 |
| f | 1 | 2 | 3 | 6 | 5 | 4 | 7 |
| g | 1 | 2 | 3 | | | 4 | |
| h | 1 | 3 | 4 | 2 | | 5 | |
| i | 1 | 4 | 5 | 2 | 3 | 6 | |
| j | 1 | 3 | 4 | 2 | 5 | 6 | |

### Flake Products

In one aspect the present invention provides flake products obtained or obtainable by the process of the present invention.

As previously mentioned, the term “flake products” as used herein is a generic term for flakes and coated flakes, which may be optionally milled. Preferably the flake products are non-metal flakes or coated non-metal flakes.

The process of the present invention may advantageously be used to prepare flake products having a low median particle diameter and/or a narrow particle size distribution preferably having a low median particle diameter and a narrow particle size distribution.

Methods traditionally used to separate wanted from unwanted particle size fractions, such as dilution with solvent, followed by wet screening, are not generally required, as the process essentially produces flake products having a uniform median particle diameter.

The term “median particle diameter” as used herein refers to a volume median particle diameter. When the flake product has a substantially circular face, the particle diameter is the diameter of the circular face. Otherwise the particle diameter is the largest dimension of the flake product.

Particle size distributions may be measured with a “Malvem Master Sizer 2000” which is a standard instrument for measuring volume percent particle size distributions.

Preferably the median particle diameter of the flake products is from 5 to 1000 μm, such as from 5 to 500 μm, 5 to 250 μm, 5 to 150 μm, 5 to 100 μm, 5 to 50 μm or 5 to 30 μm.

In another aspect, the median particle diameter of the flake products is preferably from 80 to 1000 μm, such as from 80 to 500 μm, 80 to 250 μm, 80 to 150 μm or 80 to 100 μm. In one aspect the median particle diameter is 100 μm or less, such as 80 μm or less, 50 μm or less or 30 μm or less.

As previously mentioned, the term “flake” refers to a particle having an aspect ratio of at least 3:1. Preferably the aspect ratio of the flake products is at least 5:1, more preferably at least 15:1. Higher aspect ratios are generally preferable and flake products having an aspect ratio of 100:1, such as 150:1 or above are contemplated.

According to one embodiment of the present invention the flake products are non-metal flakes. The non-metal flakes may be used in place of existing pearlescent pigments. In this aspect the optionally milled non-metal flakes are the flake products. As previously mentioned a pearlescent effect may be achieved by the use of a multi-layer flake precursor film. In a specific embodiment, the flake products may be used as an alternative to glass flake pigments for surface coatings and the mass pigmentation of polymers. The non-metal flakes may also have functional properties and may, for example impart anti-corrosive properties.

Alternatively the non-metal flakes may be coated with metal and/or a metal compound and then used to provide economical replacements for commercially available metal flake pigments. In this aspect the optionally milled, coated, non-metal flakes are the flake products. Coated non-metal flakes have a number of advantages over conventional metal flakes. For example, the non-metal material may be a relatively low cost material leading to a reduction in production costs. The coated non-metal flakes will also typically have significantly lower density than metal flakes with the result that they have much less tendency to settle in fluid application systems such as inks and paints. Furthermore, being of significantly narrower particle size distribution than conventionally milled flakes, their metallic brightness is enhanced.

The physical form of the flake products obtained from the instant process is good and they will usually be suitable for use without further processing. For maximum brightness in pigmentary applications however, it may be advantageous to gently mill or polish the surfaces of the flake products, where the flake product is amenable, to increase surface reflectance, for example to improve reflection of light.

### Pigment Composition

In one aspect, the present invention provides a pigment composition comprising flake products obtained or obtainable by the process of the present invention.

In another aspect, the present invention provides a pigment composition comprising flake products having a median particle diameter of 100 μm or less and a particle size distribution such that at least 90% by volume of the flake products have a particle diameter within ±25% of the median particle diameter, such as within ±10%, or within ±5%, or within ±3%.

The pigment compositions comprise flake products and a pigment carrier.

Preferably the flake products have a median particle diameter of 50 μm or less, such as 30 μm or less, for instance 20 μm or less, or even 10 μm or less.

In one preferred embodiment, the flake products have a particle size distribution such that at least 95% by volume of the flake products have a particle diameter within ±25% of the median particle diameter such as within ±10%, or within ±5%, or within ±3%.

### Surface Coating

In one aspect the present invention provides a surface coating comprising a pigment composition as defined herein.

The pigment composition may be added to surface coating binders dissolved or dispersed in water, solvent or mixtures of the two, to prepare a surface coating, such as an ink or paint.

The reaction of certain flake products, in particular coated flakes, in the surface coating may however be unpredictable. Where such a surface coating contains a proportion of water, there exists the possibility that reactions may occur during storage, with the formation of hydrogen gas and attendant hazards. It is therefore desirable to passivate such coated flakes in the manner described above.

### Use

The flake products obtained or obtainable by the process of the invention may have functional and/or aesthetic applications. In one aspect, the present invention provides use of flake products obtained or obtainable by the process of the invention as a pigment for instance in surface coatings or in the mass pigmentation of polymers.

Non-pigmentary applications of the flake products include flake products for electrically conductive applications, such as EMI shielding, as well as coatings providing a barrier to migration of gases and liquids, useful in food packaging. EMI shielding refers to the use of a material (the EMI shielding agent) to block spurious electromagnetic radiation that may interfere with the efficient operation of electrical equipment. A typical example is the use of nickel flakes in coatings applied to the insides of mobile phone and computer housings.

Accordingly the present invention also provides the use of flake products obtained or obtainable by the process of the invention for EMI shielding or for providing gas barrier and/or liquid barrier properties to a surface coating or food packaging.

The invention is further illustrated by the following Examples in which all parts and percentages are by weight, unless otherwise stated.

### EXAMPLES

### Example 1

A laser curable coating with a high glass transition temperature (T_{g}) was coated onto 15 μm thick Melinex film to give a dry film thickness of approximately 0.5 μm. This film was then exposed using a laser mask projection machine with a krypton fluorine excimer laser emitting at 248 nm. Attenuation was at 10% and 20× pulses of 25 ns width were used to expose each area. An area of around 1 mm×1 mm was exposed simultaneously and the substrate stepped in between, forming multiple, circular flake clones of 25 μm diameter. The cured film was rinsed with ethanol to remove the excess un-cured coating, dried and then metallised using copper under standard conditions. The cured film then had a further treatment to deposit tin and to produce a silver appearance.

Removal of the coated, non-metal flakes from the Melinex was then achieved by mechanical action to recover the desired flake products.

A solvent-based paint prepared from the flake products demonstrated a bright, slightly gold tinted sparkling silver effect in an industrial paint coating.

### Example 2

A smooth glass substrate was coated with the following mixture using a 4 micron bar coater:
1 part highly alkaline phenolic resin (Borden Chemical UK Ltd.)
1 part water
0.05 parts PEG 600 plasticiser

Using a non-contact mask composed of regularly and closely spaced 15 μm circular holes, an IR source was used to elevate the temperature of the unobscured areas to around 75° C. for 2 minutes, ramping up to 210° C. for 30 seconds. After washing off the uncured, masked areas with water, the now cured, solid, circular flakes were activated for metallisation by treatment for 30 seconds with a solution of:
80 g zirconium propionate,
30 g aluminium 2-ethyl hexanoate and
20 g palladium acetate, in 1 litre of tetrahydrofuran.

The flakes, still attached to the glass substrate, were removed from the treatment solution and cured at 350° C. for 2 minutes. During this time, the solvent is lost by evaporation. After cooling, the whole was passed rapidly through an electroless plating bath containing air agitated Circuposit electroless copper 3350 (Shipley Europe Ltd.) held at 25° C. After 10 seconds, the now copper coated flakes were removed, washed with water and separated from the glass using a doctor blade. A very bright visual effect was obtained by incorporation of the copper coated flakes in a water-based ink.

### Example 3

The method of Example 2 was followed to prepare and activate the phenolic resin flakes. Nickel plating was performed by immersing the sample in a proprietary electroless plating solution at 90° C. for 2 minutes. A layer of nickel several hundred nanometres thick was produced on the flakes. The thus coated flakes were removed from the substrate as before and incorporated in a surface coating applied to a EMI test apparatus. The EMI shielding performance was found to be comparable to a coating containing flakes of 100% nickel metal.

### Example 4

A carbon black pigmented UV curing composition (based on a Uvispeed system, Sericol Ltd.) was continuously printed onto a moving polyethylene belt to form a coherent film of uniform thickness. The film was then transported on the belt through a LC062T3 UV curing apparatus (American UV Company Inc.) at a rate of 3 m/min. Using the mask of Example 2 and at a power of 300 watts/inch, the UV-exposed portions of the film were rapidly cured. Uncured material, comprising only around 10% of the whole, was thereafter washed off by passing the belt through a solvent bath. The uniform black flakes of approximately 15 microns particle diameter were then separated from the release layer in a further washing stage accompanied by ultrasonics and thereafter recovered by filtration. Incorporating the flakes in a translucent white coating system produced an unusual and attractive visual effect.

TABLE 1
Typical aluminium pigment
D(10) (μm) 3.35
D(50) (μm) 10.11
D(90) (μm) 21.90

| size (μm) | weight % under |
|---|---|
| 0 | 0.00 |
| 1 | 0.50 |
| 2 | 3.85 |
| 3 | 8.31 |
| 4 | 13.42 |
| 5 | 19.10 |
| 6 | 25.17 |
| 7 | 31.39 |
| 8 | 37.58 |
| 9 | 43.61 |
| 10 | 49.38 |
| 12 | 59.76 |
| 14 | 68.69 |
| 16 | 76.00 |
| 18 | 81.86 |
| 20 | 86.55 |
| 22 | 90.06 |
| 24 | 92.76 |
| 26 | 94.89 |
| 28 | 96.53 |
| 30 | 97.60 |
| 34 | 99.04 |
| 38 | 99.70 |
| 42 | 99.93 |
| 46 | 99.99 |
| 50 | 100.00 |

TABLE 2
Typical pearlescent pigment
D(10) (μm) 4.79
D(50) (μm) 9.80
D(90) (μm) 18.00

| size (μm) | weight % under |
|---|---|
| 0 | 0.00 |
| 1 | 0.25 |
| 2 | 1.58 |
| 3 | 2.92 |
| 4 | 5.95 |
| 5 | 11.29 |
| 6 | 18.49 |
| 7 | 26.65 |
| 8 | 35.18 |
| 9 | 43.59 |
| 10 | 51.55 |
| 12 | 65.23 |
| 14 | 76.15 |
| 16 | 84.21 |
| 18 | 89.94 |
| 20 | 93.99 |
| 22 | 96.51 |
| 24 | 98.16 |
| 26 | 99.25 |
| 28 | 99.88 |
| 30 | 99.98 |
| 34 | 100.00 |
| 38 | 100.00 |
| 42 | 100.00 |
| 46 | 100.00 |
| 50 | 100.00 |

1. A process of preparing particulate products, the process comprising the steps of:
(i) subjecting a precursor film to a non-mechanical particulate-defining treatment; and
(ii) separating the particulate portion and the non-particulate portion of the film.

2. A process of preparing flake products, the process comprising the steps of:
(i) subjecting a flake precursor film to a non-mechanical flake-defining treatment; and
(ii) separating the flake portion and the non-flake portion of the film.

3. A process according to claim 2 wherein the flake precursor film is or is formed from a non-metal flake precursor.

4. A process according to claim 3 wherein the non-metal flake precursor is a sol gel, a resin, a polymer, a resin or polymer solution or bismuth nitrate.

5. A process according to claim 2 wherein the flake-defining treatment is UV curing, laser curing, laser ablation, cooling, heating, treatment with steam, treatment with ammonia vapour, treatment with hydrogen chloride gas or a mixture thereof.

6. A process according to claim 2 wherein the flake-defining treatment is a solidification treatment selected from UV curing or laser curing.

7. A process according to claim 6 wherein the non-flake portion of the flake precursor film is masked from the flake-defining treatment.

8. A process according to claim 2 wherein the flake-defining treatment is laser ablation.

9. A process according to claim 2 wherein the flake and non-flake portions of the flake precursor film are separated by rinsing with a solvent.

10. A process according to claim 2 further comprising the step of coating the film with metal and/or a metal compound.

11. A process according to claim 10 wherein the metal is selected from aluminium, zinc, copper, tin, nickel, silver, gold and iron.

12. A process according to claim 10 wherein the metal compound is selected from alloys comprising aluminium, zinc, copper, tin, nickel, silver, gold and/or iron and oxides of aluminium, zinc, copper, tin, nickel, silver, iron, titanium, manganese, molybdenum and silicon.

13. A process according to claim 2 further comprising the step of applying the flake precursor film to a substrate prior to the flake-defining treatment.

14. A process according to claim 13 wherein the substrate has a low friction coefficient.

15. A process according to claim 14, wherein the substrate is PTFE, silicon, a metal, glass or ceramic surface or a substrate having a release layer.

16. A process according to claim 13 wherein the flake portion of the film is removed from the substrate by mechanical means or by washing with a recovery liquid.

17. A process according to claim 16 further comprising the step of coating the flakes with metal and/or a metal compound subsequent to removal of the flake portion from the substrate.

18. A process according to claim 2 wherein the flake products are coated, non-metal flakes.

19. Flake products obtained or obtainable by the process of claim 2.

20. A pigment composition comprising flake products obtained or obtainable by the process of claim 2.

21. A surface coating comprising
(i) flake products obtained or obtainable by the process of claim 2, or
(ii) a pigment composition comprising flake products obtained or obtainable by the process of claim 2.

22. A pigment composition comprising flake products having a median particle diameter of 100 μm or less and a particle size distribution such that at least 90% by volume of the flake products have a particle diameter within ±25% of the median particle diameter.

23. A pigment composition according to claim 22 comprising flake products having a median particle diameter of 50 μm or less.

24. A pigment composition according to claim 22 comprising flake products having a median particle diameter of 30 μm or less.

25. A pigment composition according to claim 22 comprising flake products having a particle size distribution such that at least 95% by volume of the flake products have a particle diameter within ±25% of the median particle diameter.

26. A pigment composition according to claim 22 comprising flake products having a particle size distribution such that at least 95% by volume of the flake products have a particle diameter within ±3% of the median particle diameter.

27. A pigment composition according to claim 22 wherein the flake products are coated, non-metal flakes.

28. A surface coating comprising a pigment composition as defined in claim 22.

29. (canceled)

30. (canceled)

31. (canceled)

32. A method of pigmenting or providing EMI shielding properties to a composition or article, or of providing gas barrier and/or liquid barrier properties to a surface coating or food packaging, which method comprises adding flake products as defined in claim 19 to the composition, article, surface coating or food packaging.
